(19) United States
(12) Patent Application Publication
(10) Pub. No.: US 2023/0230080 A1
(43) Pub. Date: Jul. 20, 2023

(54) STORING AND RETRIEVING DATA ASSOCIATED WITH AN ASSET

(71) Applicant: RKVST Limited, Beverley (GB)

(72) Inventors: Jonathan GEATER, Cambridge (GB); Mansoor AHMED-RENGERS, Colwyn Bay (GB); Robin BRYCE, Beverley (GB)

(21) Appl. No.: 18/084,023

(22) Filed: Dec. 19, 2022

(30) Foreign Application Priority Data
Dec. 23, 2021 (GB) 2118961.8

(51) Int. Cl. G06Q 20/38

(52) U.S. Cl. CPC G06Q 20/389; G06Q 20/3825

(57) ABSTRACT

Some embodiments of the present disclosure relate to a computer implemented method of storing data associated with an asset on a blockchain. Other embodiments relate to a computer implemented method of retrieving data associated with an asset that is stored on a blockchain. The methods are performed on a blockchain node of a blockchain network.

### CROSS-REFERENCE TO RELATED APPLICATION

This application is related to and claims priority from United Kingdom Patent Application No. 2118961.8 filed Dec. 23, 2021, the entire contents of which is incorporated herein by reference for all purposes.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions.

Blockchains, and more generally distributed ledger technologies, are emerging as a fundamental building block of new digital communications platforms. The ability to securely store, trade, and compute data in a shared responsibility system with no single central point of authority is a very powerful architecture.

Blockchain and similar distributed ledger technologies are rapidly gaining legitimacy for use cases outside of the digital money space. The so-called lokenization' of physical goods and assets promise a revolution in secure trade, anti-counterfeiting, and decentralised ownership, but these use cases introduce new requirements for data management and traceability that were not so important in the original digital currency applications.

In particular, digital currency tokens have a relatively narrow range of properties which need to be updated and tracked (often just ‘current owner’, as in the very popular ERC20 and ERC721 standards). Furthermore, when the value is changed the history of the token is lost and requires expensive and usually faulty methods of tracing based not on the token itself but on transaction records on the ledger.

### SUMMARY

Currently, to prove the history of an asset (i.e., ensuring that nothing has been modified or left out of the history reported to the verifier) requires the verifier to parse the entire blockchain from the point of creation of the asset to the current block. This computational and time-based cost increases linearly over time. In the present invention, by creating event tokens, this is reduced drastically to only parsing the actual history of the asset.

Furthermore, many smart contract platforms (e.g. Ethereum) impose a “stack depth” limitation. This limits how many arguments can be passed in a single transaction. This means that doing an atomic commit to an asset that modifies a large number of attributes is infeasible.

The present invention describes a system which creates an efficient and lossless means of tracking the history of arbitrary token data elements in order to create a trustworthy ‘full-service history’ for any asset (a physical or digital object), based on its tokenized on-chain representation. The benefits of this include reducing the time involved in maintaining assets and demonstrating compliance; reducing fraud in sensitive supply chains; and proving provenance.

According to one aspect of the present disclosure there is provided a computer implemented method of storing data associated with an asset on a blockchain, the method performed on a blockchain node of a blockchain network and comprising:

receiving a request to create an event token, the request comprising a unique asset token identifier associated with an asset token, wherein the asset token comprises at least one attribute identifier identifying an attribute of the asset;

creating an event token using the unique asset token identifier, the event token comprising a unique event token identifier;

receiving a request to populate the event token, identified with the unique event token identifier, with at least one attribute value pair, each of the at least one attribute value pair comprising (i) an attribute identifier of the least one attribute identifier, and (ii) an attribute value for said attribute identifier;

modifying the event token to comprise the at least one attribute value pair;

receiving an asset token modification request, the asset token modification request comprising the unique asset token identifier and the unique event token identifier, and identifying the attribute identifier of the at least one attribute value pair;

modifying the asset token associated with the unique asset token identifier so that each attribute identifier in the asset token of the at least one attribute value pair are associated with the unique event token identifier of the event token, the event token comprising the attribute value for each attribute identifier of the at least one attribute value pair; and

after said modifying, broadcasting the asset token over the blockchain network for inclusion on the blockchain.

Modifying the event token may comprise adding a counter to the event token to indicate how many attribute value pairs are included in the event token.

The method may further comprise storing the event token in memory (e.g. on the blockchain node).

The method may further comprise maintaining the asset token in memory (e.g. on the blockchain node).

The method may further comprise modifying the event token to comprise the at least one attribute value pair comprises associating each of the at least one attribute value pair in the event token with a previous event token identifier field, the previous event token identifier field associated with a value identifying whether the attribute value is an initial value for said attribute identifier or an updated value for said attribute identifier.

In some implementations, when the attribute value is an updated value for said attribute identifier, the previous event token identifier field of the event token is associated with a unique event token identifier of a preceding event token, created before the event token, comprising an attribute value for said attribute identifier that the event token updated.

When the attribute value is an initial value for said attribute identifier, the previous event token identifier field may be associated with a null value.

The method may further comprise committing a block to the blockchain, said block comprising at least one transaction comprising data of the event token that comprises the at least one attribute value pair.

The method may comprise recording, for each of the at least one attribute value pair, (i) the unique event token identifier of the event token; (ii) the unique asset token identifier associated with the asset token; and (iii) the attribute value pair, in a data record in memory (e.g. on the blockchain node).

The method may further comprise committing a block to the blockchain, said block comprising at least one transaction comprising (i) data of the event token that comprises the at least one attribute value pair; and (ii) a hash of the data record.

The method may further comprise outputting the unique event token identifier associated with the event token.

In some implementations the request to create an event token and the request to populate the event token are received at a first address of a first smart contract, the first smart contract configured to perform said creating the event token using the unique asset token identifier, and said modifying the event token to comprise the at least one attribute value pair; and the asset token modification request is received at a second address of a second smart contract, the second smart contract configured to perform said modifying the asset token.

The method may further comprise committing a block to the blockchain, said block comprising at least one transaction comprising the at least one attribute identifier of the asset token and its associated unique event token identifier of the event token.

The method may further comprise transmitting the request to create an event token and the request to populate the event token to one or more further blockchain nodes of the blockchain network.

The method may further comprise transmitting the asset token modification request to one or more further blockchain nodes of the blockchain network, each of the one or more further blockchain nodes maintaining a copy of the asset token in memory.

According to another aspect of the present disclosure there is provided a computer implemented method of retrieving data associated with an asset that is stored on a blockchain, the method performed on a blockchain node of a blockchain network and comprising:

receiving, from a computing device, a first information retrieval request requesting contents of an asset token, the information retrieval request comprising a unique asset token identifier associated with the asset token, wherein the asset token comprises at least one attribute identifier identifying an attribute of the asset;

transmitting the contents of the asset token to the computing device;

receiving, from the computing device, a second information retrieval request comprising the unique asset token identifier and an attribute identifier of the at least one attribute identifier;

identifying at least one attribute value associated with the attribute identifier, each of the at least one attribute value stored in a respective event token which is stored on the blockchain and comprises a unique event token identifier; and

transmitting the at least one attribute value to the computing device.

A plurality of attribute values may be identified for the attribute identifier, and the method may comprise outputting the plurality of attribute values in an ordered sequence in dependence on a time of creation of the event tokens comprising the plurality of attribute values.

The method may be performed by a first smart contract on the blockchain node, and the first information retrieval request may be addressed to the first smart contract.

Identifying at least one attribute value associated with the attribute identifier may comprise:

identifying, from the asset token, a unique event token identifier associated with the attribute identifier; and

accessing an event token using the unique event token identifier to identify an attribute value associated with the attribute identifier as part of an attribute value pair.

The attribute value pair in the event token may be associated with a previous event token identifier field, and the method may comprise:

determining, from the previous event token identifier field, a unique event token identifier of a preceding event token that was created before the event token;

accessing the preceding event token; and

identifying, from the preceding event token, an attribute value for said attribute identifier that the event token updated.

The attribute value pair in the event token may be associated with a previous event token identifier field, and the method may comprise determining from the previous event token identifier field that the attribute value is an initial value for said attribute identifier.

In some implementations the method is performed by the blockchain node, outputting the contents of the asset token comprises transmitting the contents of the asset token to the computing device; and outputting the at least one attribute value comprises transmitting the at least one attribute value to the computing device.

The first information retrieval request may comprise an address of a first smart contract, the method may comprise accessing the asset token by querying a first portion of memory using the unique asset token identifier, the first portion of memory associated with the address of the first smart contract.

The identifying at least one attribute value associated with the attribute identifier may comprise:

determining from the asset token an address of a second smart contract which last generated an event token comprising an attribute value associated with the attribute identifier;

querying a second portion of memory using the unique asset token identifier and the attribute identifier, the second portion of memory associated with the address of the second smart contract; and

in response to said querying, retrieving one or more data records generated by the second smart contract, each of the data records comprising: (i) the unique asset token identifier; (ii) the attribute identifier; and (iii) an attribute value of the at least one attribute value, said attribute value associated with the attribute identifier.

In some implementations each of the data records are recorded on the blockchain, and each data record comprises a unique transaction identifier identifying a transaction on the blockchain comprising the data record, wherein the method further comprises transmitting the unique transaction identifier of each of the data records to the computing device.

In some implementations the asset referred to herein is a physical asset. In other implementations the asset is a digital asset. The asset token may be a non-fungible token.

According to another aspect of the present disclosure there is provided a computing device comprising a processor and memory, the memory storing instructions which, when executed by the processor cause the computing device to perform any of the method steps described herein.

According to another aspect of the present disclosure there is provided a computer-readable storage medium comprising instructions which, when executed by a processor of a computing cause the computing device to perform any of the method steps described herein.

The instructions may be provided on a carrier such as a disk, CD- or DVD-ROM, programmed memory such as read-only memory (Firmware), or on a data carrier such as an optical or electrical signal carrier. Code (and/or data) to implement embodiments of the present disclosure may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language.

These and other aspects will be apparent from the embodiments described in the following. The scope of the present disclosure is not intended to be limited by this summary nor to implementations that necessarily solve any or all of the disadvantages noted.

### BRIEF DESCRIPTION TO THE DRAWINGS

For a better understanding of the present disclosure and to show how embodiments may be put into effect, reference is made to the accompanying drawings in which:

FIG. 1 is schematic block diagram of a communication system;

FIG. 2 is a schematic block diagram of a blockchain node in the communication system;

FIG. 3 illustrates a known composition of a blockchain;

FIG. 4a illustrates fields of an asset token;

FIG. 4b illustrates an example asset token;

FIG. 5a is a flow chart of a process performed on a blockchain node to modify an asset token;

FIG. 5b illustrates an empty event token;

FIG. 5c illustrates an example event token populated with attribute value pairs;

FIG. 5d illustrates an example modified asset token;

FIG. 6 illustrates modification of an asset token in response to multiple event tokens;

FIG. 7 is a flow chart of a process performed on a blockchain node to read a complete history of attribute values for a particular attribute identifier of an asset token; and

FIG. 8 is a flow chart of a process performed on a blockchain node to identify attribute values associated with all event tokens comprising a particular attribute identifier of an asset token in which the event tokens comprise a pointer to an immediately preceding event token comprising an attribute value for the particular attribute identifier.

### DETAILED DESCRIPTION

Embodiments will now be described by way of example only. In particular, we use the term ‘blockchain’ to include all forms of electronic, computer-based, distributed ledgers.

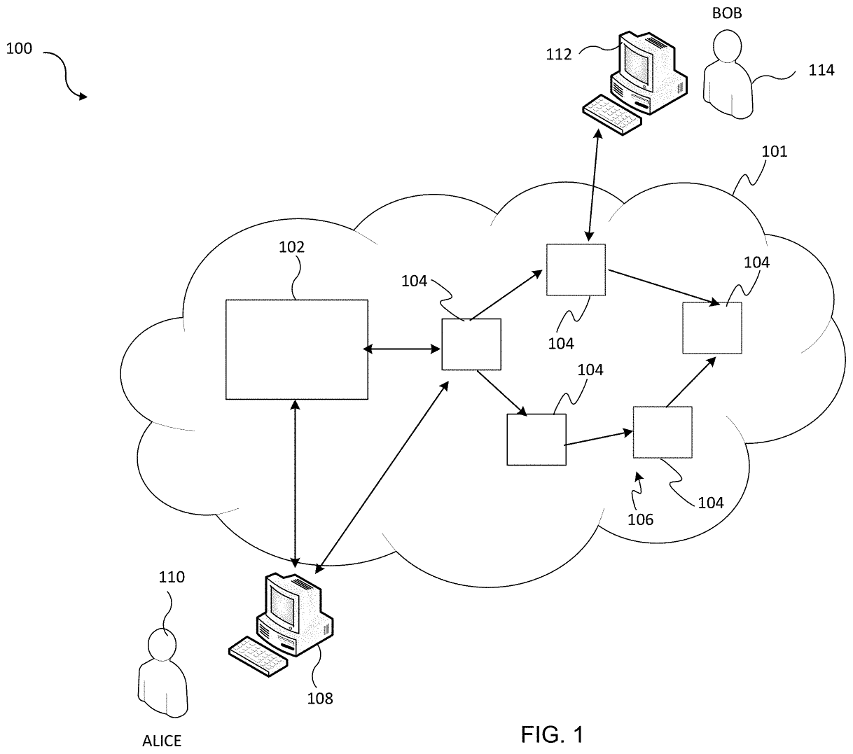

FIG. 1 shows an example communication system 100 for implementing a blockchain. The system 100 may comprise a packet-switched network 101 (e.g. the Internet). The packet-switched network 101 comprises a plurality of blockchain nodes 104 (e.g. a computer) that may be arranged to form a peer-to-peer (P2P) network 106 within the packet-switched network 101.

A respective copy of the blockchain is maintained at each of a plurality of blockchain nodes 104 in the distributed or blockchain network 106. Maintaining a copy of the blockchain does not necessarily mean storing the blockchain in full, for example each blockchain node 104 may store the block header of each block.

Each of the blockchain nodes 104 is configured to forward messages (called transactions) to other blockchain nodes 104, and thereby cause transactions to be propagated throughout the network 106. Each blockchain node 104 is configured to create blocks and to store a respective copy of the same blockchain in their respective memory. Each blockchain node 104 also maintains an ordered set (or “pool”) of transactions waiting to be incorporated into blocks.

In addition to validating transactions, blockchain nodes 104 also race to be the first to create blocks of transactions in a process commonly referred to as mining, which is supported by “proof-of-work” or any other consensus mechanism. At a blockchain node 104, new transactions are added to an ordered pool of valid transactions that have not yet appeared in a block recorded on the blockchain. In the context of a “proof-of-work” consensus mechanism, the blockchain nodes then race to assemble a new valid block of transactions from the ordered set of transactions by attempting to solve a cryptographic puzzle.

The first blockchain node 104 to solve the puzzle announces this to the network 106, providing the solution as proof which can then be easily checked by the other blockchain nodes 104 in the network. The first blockchain node 104 propagates a block to a threshold consensus of other nodes that accept the block and thus enforce the protocol rules. The ordered set of transactions then becomes recorded as a new block in the blockchain by each of the blockchain nodes 104. Each transaction sent by every node is recorded on the blockchain; thus the blockchain is the source of truth for everything that happened within that blockchain network.

The memory of each blockchain node 104 stores software configured to run on the processing apparatus of the blockchain node 104 in order to perform its respective role and handle transactions.

Also connected to the network 101 is one or more computing devices. For simplicity, and merely as an example, FIG. 1 shows a first computing device 108 associated with a first user Alice 110 and a second computing device 112 associated with a second user Bob 114.

The computing devices 108,112 may interact with the blockchain network 106 but do not participate in validating transactions or constructing blocks.

The computing devices 108,112 may interact with the blockchain network 106 and thereby utilize the blockchain by connecting to (i.e. communicating with) a blockchain node 104. The computing devices 108,112 may send and receive transactions. As shown in FIG. 1, the computing devices 108,112 may interact with a blockchain node 104 directly or via a server 102 that is connected to the packet-switched network 101. The server 102 is not part of the blockchain network 106 but is connected to one or more blockchain nodes 104 of the blockchain network 106.

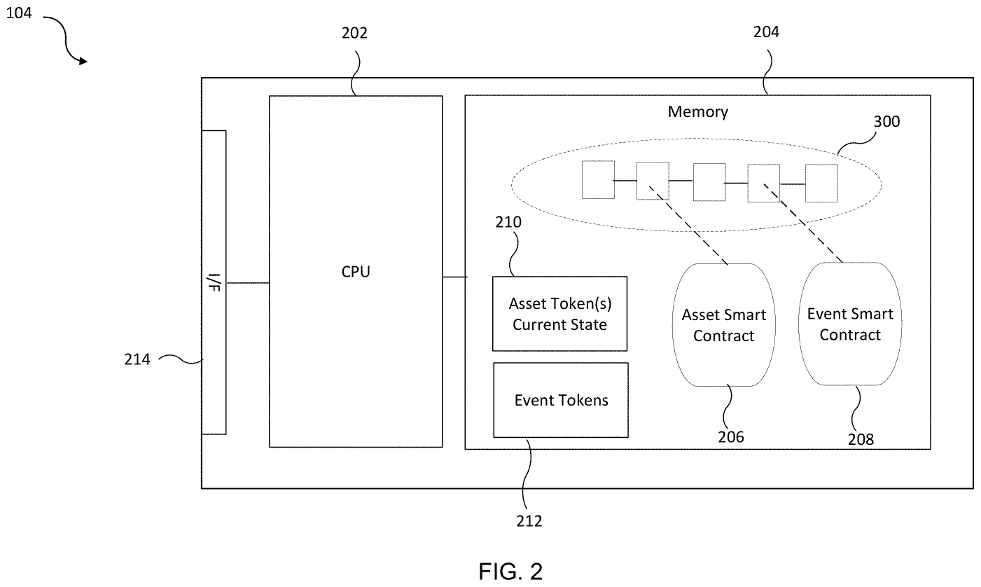

FIG. 2 is a schematic block diagram of a blockchain node 104 in the communication system 100.

As shown in FIG. 2, the blockchain node 104 comprises a processing apparatus 204 comprising one or more processors, e.g. one or more central processing units (CPUs), accelerator processors, application specific processors and/or field programmable gate arrays (FPGAs), and other equipment such as application specific integrated circuits (ASICs).

The processing apparatus 204 is coupled to a communications interface 214 which allows the blockchain node 104 to receive and transmit data. As will be appreciated the communications interface 214 allows the blockchain node 104 to communicate with other blockchain nodes 104, the server 102, and the computing devices 108,112.

Each blockchain node 104 also comprises a memory 204, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

A respective copy of a blockchain 300 is maintained in the memory 204 of the blockchain node 104. As noted above, maintaining a copy of the blockchain does not necessarily mean storing the blockchain in full, for example each blockchain node 104 may store the block header of each block.

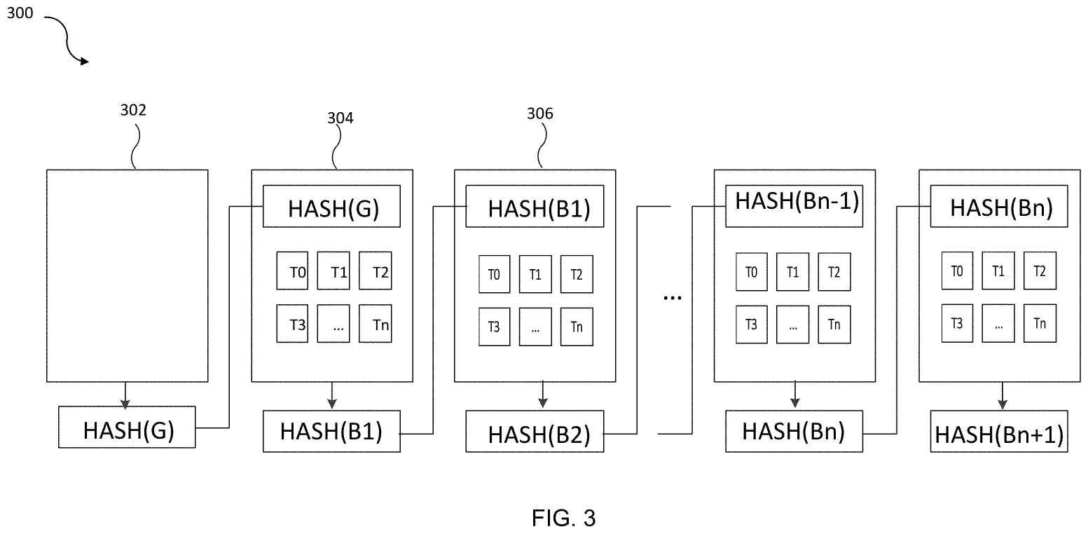

The blockchain 300 is illustrated in FIG. 3. At the beginning of the blockchain there is a genesis block 302. As shown in FIG. 3, each block comprises at least one portion of data (labelled as T0-Tn), commonly referred to as transactions. A transaction in this context refers to a kind of data structure, the format of which is dependent on the distributed ledger technology. Each block that follows the genesis block 302 comprises the cryptographic hash of the preceding block (referred to herein as a linking hash). For example, as shown in FIG. 3, block 1 (B1) 304 comprises the cryptographic hash, HASH(G)—a linking hash, of the preceding block (the genesis block 302). Similarly, block 2 (B2) 306 comprises the cryptographic hash, HASH (B1)—a linking hash, of the preceding block (block 304). Expressed another way, the cryptographic hash of each block is stored in its successor. Each block comprises a block pointer pointing back to the previously created block in the chain so as to define a sequential order to the blocks. Each transaction comprises a pointer back to a previous transaction so as to define an order to sequences of transactions.

As shown in FIG. 2, the memory 204 also stores an asset smart contract 206 and an event smart contract 208.

The asset smart contract 206 comprises computer program code (executable by the CPU 202) which comprises rules that can process inputs in order to produce results. The asset smart contract 206 is associated with an asset smart contract address. The asset smart contract 206 is invoked with the blockchain node 104 receives a transaction comprising the asset smart contract address. The asset smart contract 206 is associated with a portion of memory 204 of the blockchain node 104. In dependence on the distributed ledger technology, the asset smart contract 206 may be represented in a transaction on the blockchain 300 (e.g. in the context of Ethereum). The asset smart contract 206 is operable to create and modify one or more asset tokens. As shown in FIG. 2, a portion of the memory 204 associated with the asset smart contract 206 stores asset token(s) 210 i.e. the current (latest) state of each of the asset token(s). That is, local storage on the blockchain node 104 maintains the current state of the asset token(s). For each asset token, one or more transactions recorded on the blockchain represent the current state of the asset token. Previous transactions recorded on the blockchain journal the history of changes to the current state, these previous transaction represent previous states of the asset token, not the current state of the asset token. Further explanation on an asset token is provided below.

In a similar manner, the event smart contract 208 comprises computer program code (executable by the CPU 202) which comprises rules that can process inputs in order to produce results. The event smart contract 208 is associated with an event smart contract address. The event smart contract 208 is invoked with the blockchain node 104 receives a transaction comprising the event smart contract address. The event smart contract 208 is associated with a portion of memory 204 of the blockchain node 104. In dependence on the distributed ledger technology, the event smart contract 208 may be represented in a transaction on the blockchain 300 (e.g. in the context of Ethereum). The event smart contract 208 is operable to create event tokens. As shown in FIG. 2, a portion of the memory 204 associated with the event smart contract 208 stores event tokens 212. Further explanation of an event token is provided below.

The invocation and subsequent execution of the contract code of the asset smart contract 206 and the event smart contract 208 is duplicated across all of the blockchain nodes 104 thus ensuring that the entire blockchain network 106 is in consensus about what the state of each smart contract is.

In the context of the present disclosure, an asset is a physical or digital object. For example, in the context of a physical asset the asset may be a car, factory machine, computing device, building etc. In the context of a digital object the digital object may be an image, a word processing document, a spreadsheet, an audio file etc. Each asset is represented by a single asset token. To create an asset token a computing device transmits one or more asset token creation transactions to the asset smart contract 206. That is, the asset token creation transaction(s) comprises the asset smart contract address. Thus, once the asset token creation transaction(s) are received at a blockchain node 104, the asset smart contract 206 is invoked when the blockchain node 104 processes the asset token creation transaction(s). The asset token creation transaction(s) comprise at least one attribute identifier which identifies an attribute of the asset. In response to receiving the asset token creation transaction(s), the asset smart contract 206 creates an asset token with a unique asset token identifier. The asset token comprises the at least one attribute identifier. In an asset token, each of the attribute identifiers is associated with (i) an event token identifier which identifies an event token storing the latest attribute value for the attribute identifier, and (ii) the event smart contract address of the event smart contract which created the event token storing the latest attribute value for the attribute identifier. The asset token does not store the attribute values themselves. At the time of creation of the asset token, none of the attribute identifiers have an attribute value associated with them therefore, all the event token identifiers have a NULL value.

In response to creating the asset token, the asset smart contract 206 outputs one or more transactions, comprising data representing the asset token, to the pool of transactions waiting to be incorporated into blocks which is maintained by the blockchain node 104. Thus the created asset token gets recorded on the blockchain 300 in one or more transactions. The asset smart contract 206 also stores the current state of the newly created asset token in memory 204 associated with the asset smart contract 206.

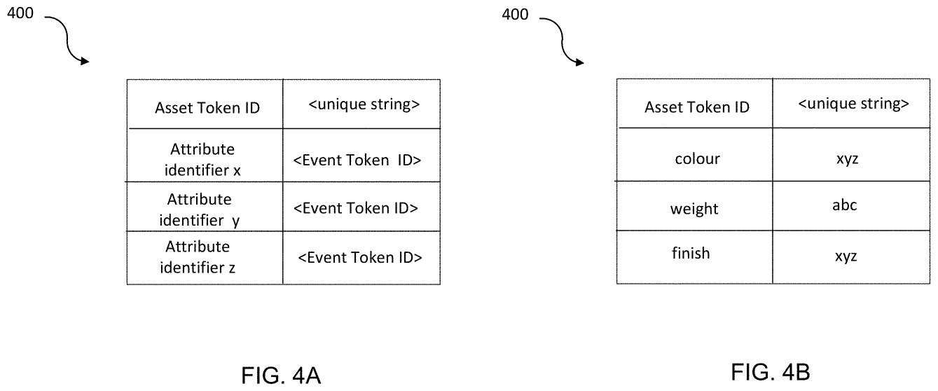

FIG. 4a illustrates an example asset token 400 comprising a unique asset token identifier of “<unique string>”. The example asset token 400 also comprises three attribute identifiers “attribute identifier x”, “attribute identifier y”, and “attribute identifier z”. As shown in FIG. 4a, each of the three attribute identifiers in the example asset token 400 is associated with an event token identifier. Some or all of the event token identifiers may be the same. Alternatively, the all of the event token identifiers may be different. As noted above, at the time of creation of the asset token, all of the event token identifiers have a NULL value.

FIG. 4b illustrates the example asset token 400, after event tokens have been created to store an attribute value for each of the attribute identifiers. In the context of the asset being a physical object (e.g. a car), the three attribute identifiers may be “colour”, “weight”, and “finish”. The example asset token 400 shown in FIG. 4b comprises an event token identifier ‘xyz’ associated with attribute identifier “colour” which indicates that the event token associated with the unique event token identifier ‘xyz’ comprises the latest attribute value (e.g. blue) for the attribute identifier “colour”. The example asset token 400 shown in FIG. 4b comprises an event token identifier ‘abc’ associated with attribute identifier “weight” which indicates that the event token associated with the unique event token identifier ‘abc’ comprises the latest attribute value (e.g. 120) for the attribute identifier “weight”. The example asset token 400 shown in FIG. 4b comprises an event token identifier ‘xyz’ associated with attribute identifier “finish” which indicates that the event token associated with the unique event token identifier ‘xyz’ comprises the latest attribute value (e.g. gloss) for the attribute identifier “finish”.

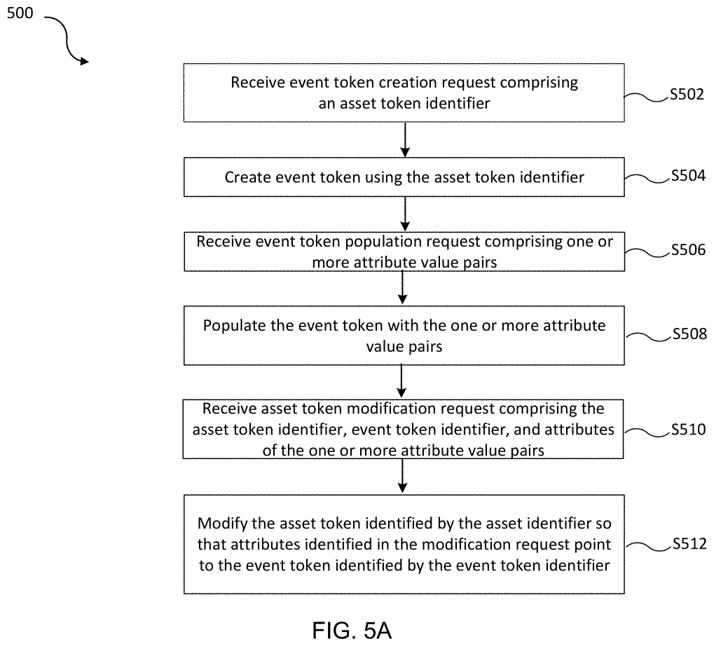

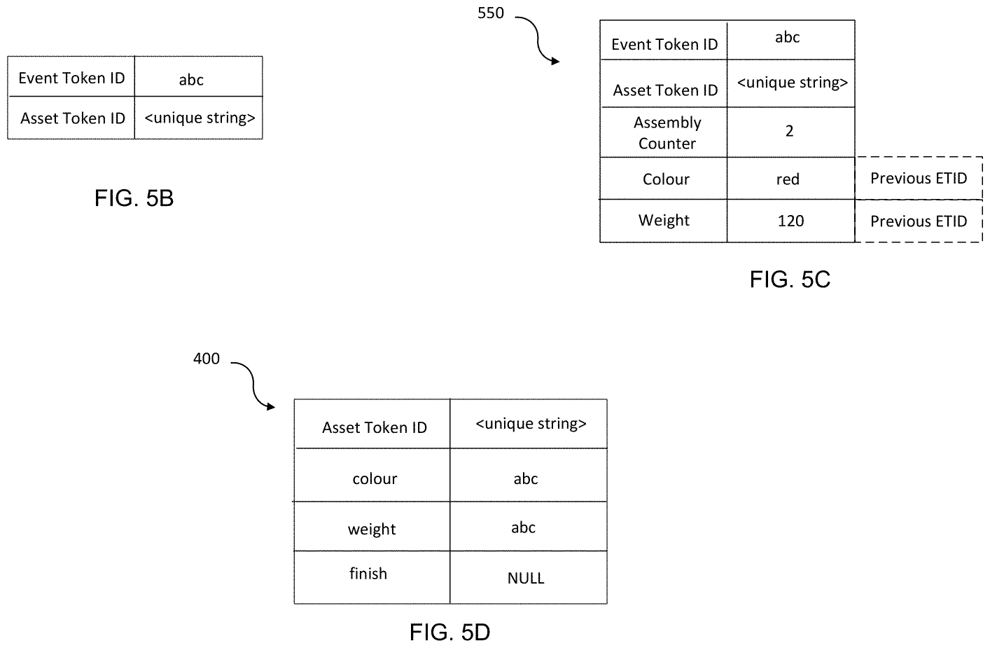

We now refer to FIG. 5a which is a flow chart 500 of a process performed on a blockchain node 104 to modify an asset token. By way of example, FIG. 5a is described with reference to the blockchain node 104 receiving data from the first computing device 108 associated with the first user Alice 110 who wants to store data associated with an asset on the blockchain 300. In other embodiments, the first user Alice 110 communicates with server 102 which acts an intermediary and is operable to communicate with the blockchain node 104 as described below.

At step S502, the event smart contract 208 running on the blockchain node 104 receives an event token creation request (e.g. an event token creation transaction) from the first computing device 108. The event token creation transaction is addressed to the event smart contract 208 and thus comprises the event smart contract address associated with the event smart contract 208. Thus, once the event token creation transaction is received at the blockchain node 104, the event smart contract 208 is invoked when the blockchain node 104 processes the event token creation transaction. The event token creation transaction comprises a unique asset token identifier associated with an asset token 400 that the first user Alice 110 wants to update.

At step S504, the event smart contract 208 creates an event token. The event token created after step S504 is shown in FIG. 5b. The event smart contract 208 outputs a transaction comprising the event token data to the pool of transactions waiting to be incorporated into blocks. This transaction is also broadcast to other blockchain nodes to be added to their respective pool of transactions waiting to be incorporated into blocks.

As shown in FIG. 5b, the event token comprises a unique event token identifier (e.g. ‘abc’), and the unique asset token identifier (e.g. ‘<unique string>’) referenced in the event token creation transaction. The event smart contract 208 outputs the unique event token identifier associated with the event token such that it can become known by the first computing device 108.

At step S506, the event smart contract 208 receives an event token population request (e.g. an event token population transaction) that is addressed to the event smart contract 208, from the first computing device 108. The event token population transaction comprises the unique event token identifier (e.g. ‘abc’) and at least one attribute value pair, each of the at least one attribute value pair comprising (i) an attribute identifier included in the asset token that is associated with the unique asset token identifier (e.g. ‘<unique string>’), and (ii) an attribute value for the attribute identifier.

At step S508, the event smart contract 208 modifies the event token to comprise the at least one attribute value pair. The event smart contract 208 may output a transaction comprising the populated event token data to the pool of transactions waiting to be incorporated into blocks. This transaction is also broadcast to other blockchain nodes to be added to their respective pool of transactions waiting to be incorporated into blocks.

An example event token 550 created after step S508 is shown in FIG. 5c. In the example of FIG. 5c, the event token population transaction included a first attribute value pair comprising the attribute identifier ‘colour’ included in the asset token 400, and an attribute value ‘red’; and a second attribute value pair comprising the attribute identifier ‘weight’ included in the asset token 400, and an attribute value ‘120’. In embodiments of the present disclosure an event token is created to comprise an attribute value for one or more of the attribute identifiers stored in exactly one asset token which it modifies.

The event smart contract 208 stores the populated event token 550 in memory 204. It will be appreciated from the above that the populated event token 550 is also stored on the blockchain 300 in one or more transactions. That is, the blockchain node 104 will commit a block to the blockchain, the block comprising at least one transaction comprising data of the populated event token 550 as a result of the blockchain node 104 or other blockchain node 104 assembling a new valid block of transactions from their ordered set of transactions by attempting to solve a cryptographic puzzle (or using an alternative consensus mechanism).

In some embodiments, the event smart contract 208 associates each attribute value pair in the event token with a previous event token identifier field, whereby the previous event token identifier field has a value identifying whether the attribute value is an initial value for said attribute identifier or an updated value for said attribute identifier. When the attribute value is an initial value for an attribute identifier, the previous event token identifier field is associated with a NULL value. In contrast, when the attribute value is an updated value for an attribute identifier, the previous event token identifier field of the event token 550 comprises (i) a unique event token identifier of a preceding event token, created before the event token 550, which comprises an attribute value for the attribute identifier that the event token 550 updated; and (ii) an event smart contract address of the event smart contract which created the preceding event token. Thus the previous event token identifier field of an event token 550 associated with an attribute identifier acts as a pointer to a preceding event token that most recently set an attribute value for the attribute identifier. Such pointers may be used to trace the complete history of attribute values for a particular attribute identifier. It will be appreciated from the below that use of such a previous event token identifier field is optional.

In other embodiments such pointers are not used. In these embodiments step S508 comprises the event smart contract 208 outputting, to the portion of memory 204 associated with the event smart contract 208, a data record for each attribute identifier the populated event token 550. Each data record comprises (i) the unique event token identifier (e.g. ‘abc’) of the event token 550; (ii) the unique asset token identifier (e.g. ‘<unique string>’) associated with the asset token; and (iii) the attribute identifier (e.g. colour); and (iv) the attribute value (e.g. red) associated with the attribute identifier. In these embodiments, the transaction comprising the populated event token that gets committed to the blockchain 300 comprises a hash of the data record. Each data record is stored in the portion of memory 204 associated with the event smart contract 208 together with a unique transaction identifier of the transaction on the blockchain which comprises the hash of the data record. In the context of an Ethereum blockchain, the data record corresponds to a log' emitted by the event smart contract 208. Such data records may be used to trace the complete history of attribute values for a particular attribute identifier.

Step S508 may further comprise adding a counter (see ‘assembly counter’) to the event token 550 to indicate how many attribute value pairs are included in the event token 550.

At step S510, the asset smart contract 206 running on the blockchain node 104 receives an asset token modification request (e.g. an asset token modification transaction) from the first computing device 108.

The asset token modification transaction is addressed to the asset smart contract 206 and thus comprises the asset smart contract address associated with the asset smart contract 206. Thus, once the asset token modification transaction is received at the blockchain node 104, the asset smart contract 206 is invoked when the blockchain node 104 processes the asset token modification transaction. The asset token modification transaction comprises a unique asset token identifier associated with an asset token 400 that the first user Alice 110 wants to update. The asset token modification transaction further comprises a unique event token identifier and at least one attribute value pair.

Taking the example of the first user Alice 110 wanting to update an asset token 400 using the event token 550, the asset token modification transaction would comprise the unique asset token identifier ‘<unique string>’, a first attribute value pair comprising the attribute identifier ‘colour’ and the attribute value ‘red’; and a second attribute value pair comprising the attribute identifier ‘weight’ and the attribute value ‘120’.

At step S512, the asset smart contract 206 modifies the asset token 400 so that each attribute identifier in the asset token 400 that is referred to in the event token 550 is associated with the unique event token identifier (e.g. ‘abc’) of the event token 550. After the asset token 400 has been modified, the asset smart contract 206 outputs a transaction comprising the asset token to the pool of transactions waiting to be incorporated into blocks. This transaction also gets broadcast to other blockchain nodes to be added to their respective pool of transactions waiting to be incorporated into blocks.

FIG. 5d illustrates an example asset token 400 modified after execution of step S510. As shown in FIG. 5d the attribute identifier ‘colour’ and the attribute identifier ‘weight’ are no longer associated with a NULL value, and are instead each associated with the unique event token identifier (‘abc’) of the event token 550 comprising the attribute value for the attribute identifier. Each of the attribute identifier ‘colour’ and the attribute value ‘red’ are also associated with the event smart contract address of the event smart contract 208 which created the event token 550 storing the latest attribute value for the attribute identifier ‘colour’ and the attribute identifier ‘weight’. In the example asset token 400 shown in FIG. 5d, an event token having an attribute value for the attribute identifier ‘finish’ has not yet been created and thus the attribute identifier ‘finish’ is associated with a NULL value.

It will be appreciated that over time, the process 500 is performed by the blockchain node 104 each time a user wants to update an asset token associated with a particular asset.

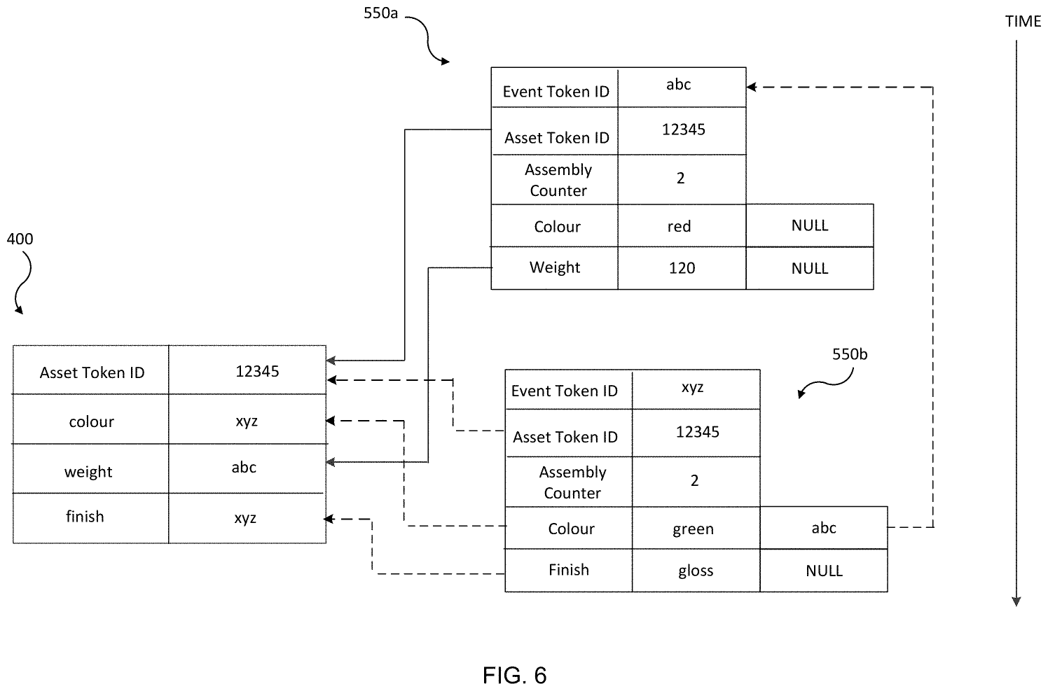

FIG. 6 illustrates a simple example of how an asset token 400 may be modified over time.

In particular, FIG. 6 illustrates how the process 500 was first performed to create a first event token 550a having the unique event token identifier ‘abc’ and comprising an attribute value for the attribute identifiers ‘colour’ and ‘weight’ of the asset token; and to update the asset token to associate the attribute identifier ‘colour’ with the unique event token identifier ‘abc’ of the event token 550a and to associate the attribute identifier ‘weight’ with the unique event token identifier ‘abc’ of the event token 550a.

FIG. 6 also illustrates how the process 500 was later performed to create a second event token 550b having the unique event token identifier ‘xyz’ and comprising an attribute value for the attribute identifiers ‘colour’ and ‘finish’ of the asset token; and to update the asset token to associate the attribute identifier ‘colour’ with the unique event token identifier ‘xyz’ of the event token 550b and to associate the attribute identifier ‘finish’ with the unique event token identifier ‘xyz’ of the event token 550a.

Thus, as can be seen the asset token 400 is modified so that the attribute identifier ‘colour’ is associated with the unique event token identifier ‘xyz’ of the most recent event token 550b comprising an attribute value for the attribute identifier ‘colour’.

FIG. 6 also illustrates the attribute identifiers ‘colour’ and ‘weight’ of the first event token 550a being associated with a previous event token identifier field.

In the first event token 550a the previous event token identifier field associated with the attribute identifier ‘colour’ has a NULL value indicating that the attribute value ‘red’ is an initial (i.e. first) value for the attribute identifier ‘colour’ of the asset token 400. In the first event token 550a the previous event token identifier field associated with the attribute identifier ‘weight’ also has a NULL value indicating that the attribute value ‘120’ is an initial (i.e. first) value for the attribute identifier ‘weight’ of the asset token 400.

In the later second event token 550b the previous event token identifier field associated with the attribute identifier ‘colour’ comprises the unique event token identifier ‘abc’ of the preceding event token 550a, created before the event token 550b, which comprises an attribute value for the attribute identifier ‘colour’ that the event token 550b updated. In the later second event token 550b the previous event token identifier field associated with the attribute identifier ‘finish’ has a NULL value indicating that the attribute value ‘gloss’ is an initial (i.e. first) value for the attribute identifier ‘finish’ of the asset token 400.

When the attribute value is an initial value for an attribute identifier, the previous event token identifier field is associated with a NULL value. In contrast, when the attribute value is an updated value for an attribute identifier, the previous event token identifier field of the event token 550 is associated with a unique event token identifier of a preceding event token, created before the event token 550, comprising an attribute value for the attribute identifier that the event token 550 updated. Thus the previous event token identifier field of an event token 550 associated with an attribute identifier acts as a pointer to a preceding event token that most recently set an attribute value for the attribute identifier. It will be appreciated from the below that use of such a previous event token identifier field is optional.

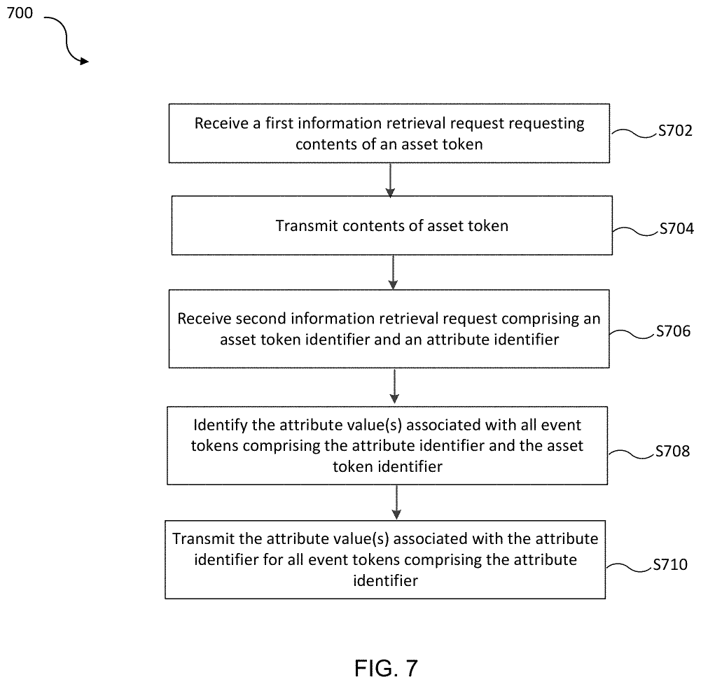

FIG. 7 is a flow chart of a process 700 performed on a blockchain node 104 to read a complete history of attribute values for a particular attribute identifier of an asset token. For example the CPU 202 may perform the steps of the process 700.

By way of example, FIG. 7 is described with reference to the blockchain node 104 being in communication with the first computing device 108 associated with the first user Alice 110 who wants to receive the current attribute value and also the history of attribute values of an attribute identifier of an asset token. In other embodiments, the first user Alice 110 communicates with the server 102 which is operable to communicate with the blockchain node 104 as described below.

In embodiments of the present disclosure the user wanting to receive the current attribute value and also the history of attribute values of an attribute identifier of an asset token may have used their computing device to create one or more of the event tokens that comprise an attribute value that they are enquiring about. Alternatively, the user wanting to receive the current attribute value and also the history of attribute values of an attribute identifier of an asset token may have had no involvement in the creation of one or more of the event tokens that comprise an attribute value that they are enquiring about.

At step S702 the blockchain node 104 receives a first information retrieval request from the first computing device 108, the first information retrieval request requesting contents of an asset token. The first information retrieval request comprises a unique asset token identifier associated with the asset token.

At step S704, the blockchain node 104 retrieves the current state of the asset token from memory 204 associated with the asset smart contract 206 and transmits the contents of the asset token to the first computing device 108.

At step S706, the blockchain node 104 receives a second information retrieval request from the first computing device 108, the second information retrieval request comprising the unique asset token identifier associated with the asset token, and an attribute identifier included in the asset token. Thus the second information retrieval request acts to request all attribute values for the particular attribute identifier of the asset token.

At step S708 the blockchain node 104 identifies attribute values associated with all event tokens which comprise the attribute identifier and the unique asset token identifier included in the second information retrieval request.

At step S710, the blockchain node 104 transmits the identified attribute values to the first computing device 108.

Step S708 may be performed in a number of different ways.

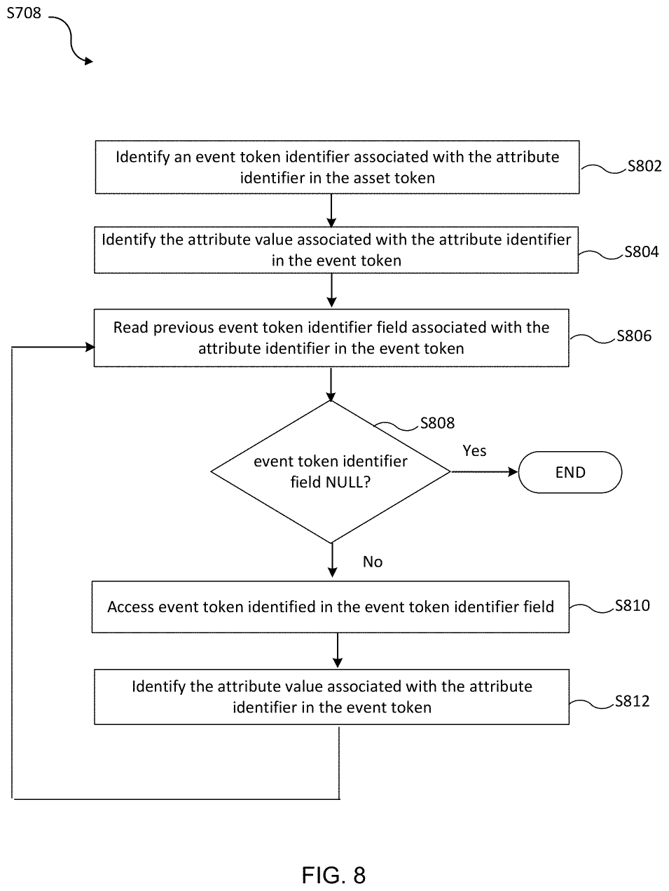

FIG. 8 illustrates a first example implementation (referred to herein as a “hard pointer” method) of how step S708 may be performed in embodiments whereby the event smart contract 208 associates each attribute value pair in the event token with a previous event token identifier field.

At step S802, the blockchain node 104 identifies, from the asset token, (i) an event token identifier which identifies an event token storing the latest attribute value for the attribute identifier included in the second information retrieval request, and (ii) the event smart contract address of the event smart contract which created the event token storing the latest attribute value for the attribute identifier.

Taking FIG. 6 and the attribute identifier ‘colour’ as an example, at step S802 the blockchain node 104 would identify the event token identifier ‘xyz’ and the event smart contract address of the event smart contract 208 which created the event token 550b.

At step S804, the blockchain node 104 identifies the attribute value associated with the attribute identifier included in the second information retrieval request.

Referring to the above example, at step S804 the blockchain node 104 would identify the attribute value ‘green’ associated with the attribute identifier ‘colour’ in the event token 550b.

At step S806, the blockchain node 104 reads the previous event token identifier field associated with the attribute identifier.

Referring to the above example, at step S806 the blockchain node 104 would read the previous event token identifier field associated with the attribute identifier ‘colour’ in the event token 550b.

At step S808, the blockchain node 104 determines whether the previous event token identifier field has a NULL value (i.e. whether there is a preceding event token that was created before the event token which comprises an attribute value for the attribute identifier).

If the previous event token identifier field has a NULL value, this indicates that there are no further which comprises an attribute value for the attribute identifier, then step S708 is complete.

If the previous event token identifier field does not have a NULL value, and instead comprises a unique event token identifier of a preceding event token (and an event smart contract address of the event smart contract which created the preceding event token), the process proceeds to step S810.

Referring to the above example, at step S808 the blockchain node 104 would identify that the attribute identifier ‘colour’ is associated with a previous event token identifier field comprising the unique event token identifier ‘abc’ of the preceding event token 550a, created before the event token 550b, which comprises an attribute value for the attribute identifier ‘colour’ that the event token 550b updated.

At step S810, the blockchain node 104 accesses the preceding event token associated with the unique event token identifier read at step S806. In particular, the blockchain node accesses the preceding event token from a portion of memory 204 associated with the event smart contract address read at step S808.

Referring to the above example, at step S810 the blockchain node 104 would access the preceding event token 550a from the portion of memory 204 associated with the event smart contract 208.

At step S812, the blockchain node 104 identifies the attribute value associated with the attribute identifier included in the preceding event token 550a. Referring to the above example, at step S812 the blockchain node 104 would identify the attribute value ‘red’ associated with the attribute identifier ‘colour’ in the event token 550a.

As shown in FIG. 8 the process then loops back to step S806 whereby the blockchain node 104 reads the previous event token identifier field associated with the attribute identifier in the event token accessed at step S810.

Referring to the above example, at step S806 the blockchain node 104 would read the previous event token identifier field associated with the attribute identifier ‘colour’ and step S708 would end after discovering that the previous event token identifier field of the event token 550a comprises a NULL value (indicating that the event token 550a was the first event token to set an attribute value for the attribute identifier ‘colour’).

It will be appreciated that once step S708 ends the blockchain node 104 will have obtained the attribute values associated with all event tokens which comprise the attribute identifier in the second information retrieval request.

We now refer to an alternative method of performing step S708 in embodiments where the previous event token identifier field is not used, and instead the event smart contract 208 outputs, to the portion of memory 204 associated with the event smart contract 208, a data record for each attribute identifier in a populated event token 550. This is referred to herein as a “logical relation” method.

In this alternative method, the blockchain node 104 identifies, from the asset token (associated with the unique asset token identifier identified in the second information retrieval request) an event smart contract address of the event smart contract 208 which created the event token storing the latest attribute value for the attribute identifier (identified in the second information retrieval request).

The blockchain node 104 then queries the portion of memory associated with the event smart contract address using the unique asset token identifier and the attribute identifier included in the second information retrieval request.

In response to this query, the blockchain node 104 is able to retrieve all of the data records (one or more data records) which comprise the unique asset token identifier and the attribute identifier. Each of the retrieved data records comprise (i) the unique asset token identifier; (ii) the attribute identifier; and (iii) an attribute value associated with the attribute identifier.

As noted above, each data record is stored in the portion of memory 204 associated with the event smart contract 208 together with a unique transaction identifier of the transaction on the blockchain which comprises the hash of the data record. The blockchain node 104 can determine the temporal order of the attribute values (i.e. what was the initial attribute value for the attribute identifier and how the attribute values for the attribute identifier changed over time) using the unique transaction identifier associated with each data record. Thus the blockchain node 104 may transmit an ordered list of the attribute value to the computing device, the ordering based on when each data record was created.

In these embodiments, at step S710 the blockchain node 104 may further transmit the unique transaction identifier of each of the data records (comprising the unique asset token identifier and the attribute identifier) to the computing device. This enables the first user Alice 110 to independently verify that the identified attribute values transmitted to the first computing device 108 are correct and are complete (i.e. there are no missing attribute values).

By performing the process 700, a user is able to trace the complete history of attribute values for a particular attribute identifier of an asset token and be assured that the received attributes for the particular attribute identifier are correct and are complete (i.e. there are no missing attribute values).

The execution cost for processing each value in an asset attribute identifier's history differs between the “hard pointer” and “logical relation” methods described above.

For the hard pointer method the blockchain node must execute smart contract code for each of the N values in the attribute identifier's history. This is typically much more computationally expensive than the logical relation method and it inhibits the blockchain node's ability to process other requests. However, once done, the requesting computing device does not need to perform any further steps to be certain of the validity of the history of values obtained for a particular attribute identifier.

For the logical relation method, the execution cost per item (value of an asset attribute identifier) in the asset attribute identifier's history of values is negligible. However depending on the distributed ledger technology used, the requesting computing device may perform a proof check for each item retrieved to independently verify such values are recorded on the blockchain. Thus the burden of proof checking is placed on the requesting computing device in the logical relation method.

In some embodiments, a user may not wish to receive the complete history of attribute values for a particular attribute identifier of an asset token, and may instead be interested in a subset of the attributes. The user may specify the subset in the second information retrieval request. For example, the user may specify a numerical range in the second information retrieval request indicative of a position in a sequence of event tokens comprising an attribute value for the particular attribute identifier (e.g. 1-10 if the user is only interested in the early history of a particular asset). The user can perfectly reconstruct the complete history of attribute values for a particular attribute identifier of an asset token by making a series of suitable ‘range’ requests.

Whilst embodiments of the present disclosure have been described with reference to two smart contracts (the asset smart contract 206 and the event smart contract 208), this is merely an example. Multiple smart contracts may perform the functionality of the asset smart contract 206.

Similarly, multiple smart contracts may perform the functionality of the event smart contract 208. This can enable improved querying facilities for the requesting computing device (e.g. by specifying an identifier of one of the multiple event smart contract that is dedicated to recording data in event tokens according to specific rules).

The functionality described above in relation to the asset smart contract 206 and the event smart contract 208 may be performed by a single smart contract. However, it is advantageous to utilise a separate asset smart contract 206 and event smart contract 208. In particular, utilising a separate asset smart contract 206 and event smart contract 208 enables reducing the computational cost and time to migrate data (event tokens) when the event smart contract 208 needs to be replaced (e.g. for upgrade purposes).

Whilst embodiments of the present disclosure have been described with reference to the memory associated with the event smart contract 208 and the memory associated with the asset smart contract 206 corresponding to local storage on the blockchain nodes 104, this is merely an example.

The memory associated with the asset smart contract 206 may be on the blockchain node 104 or external to the blockchain node 104. Similarly, the memory associated with the event smart contract 208 may be on the blockchain node 104 or external to the blockchain nodes 104.

In the present disclosure, the term memory is intended to encompass any computer readable storage medium and/or device (or collection of data storage mediums and/or devices). Examples of data stores include, but are not limited to, optical disks (e.g., CD-ROM, DVD-ROM, etc.), magnetic disks (e.g., hard disks, floppy disks, etc.), memory circuits (e.g., EEPROM, solid state drives, random-access memory (RAM), etc.), and/or the like. Further, a data store or memory may be comprised of a single medium/device or a plurality of mediums/devices, optionally comprising a plurality of different mediums/devices.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method of storing data associated with an asset on a blockchain, the method performed on a blockchain node of a blockchain network and comprising:
receiving a request to create an event token, the request comprising a unique asset token identifier associated with an asset token, wherein the asset token comprises at least one attribute identifier identifying an attribute of the asset;
creating an event token using the unique asset token identifier, the event token comprising a unique event token identifier;
receiving a request to populate the event token, identified with the unique event token identifier, with at least one attribute value pair, each of the at least one attribute value pair comprising (i) an attribute identifier of the least one attribute identifier, and (ii) an attribute value for said attribute identifier;
modifying the event token to comprise the at least one attribute value pair;
receiving an asset token modification request, the asset token modification request comprising the unique asset token identifier and the unique event token identifier, and identifying the attribute identifier of the at least one attribute value pair;
modifying the asset token associated with the unique asset token identifier so that each attribute identifier in the asset token of the at least one attribute value pair are associated with the unique event token identifier of the event token, the event token comprising the attribute value for each attribute identifier of the at least one attribute value pair; and
after said modifying, broadcasting the asset token over the blockchain network for inclusion on the blockchain.

2. The computer implemented method of claim 1, wherein modifying the event token comprises adding a counter to the event token to indicate how many attribute value pairs are included in the event token.

3. The computer implemented method of claim 1, further comprising storing the event token in memory.

4. The computer implemented method of claim 1, further comprising maintaining the asset token in memory.

5. The computer implemented method of claim 1, wherein modifying the event token to comprise the at least one attribute value pair comprises associating each of the at least one attribute value pair in the event token with a previous event token identifier field, the previous event token identifier field associated with a value identifying whether the attribute value is an initial value for said attribute identifier or an updated value for said attribute identifier.

6. The computer implemented method of claim 5, wherein when the attribute value is an updated value for said attribute identifier, the previous event token identifier field of the event token is associated with a unique event token identifier of a preceding event token, created before the event token, comprising an attribute value for said attribute identifier that the event token updated.

7. The computer implemented method of claim 5, wherein when the attribute value is an initial value for said attribute identifier, the previous event token identifier field is associated with a null value.

8. The computer implemented method of claim 1, further comprising committing a block to the blockchain, said block comprising at least one transaction comprising data of the event token that comprises the at least one attribute value pair.

9. The computer implemented method of claim 1, the method comprising recording, for each of the at least one attribute value pair, (i) the unique event token identifier of the event token; (ii) the unique asset token identifier associated with the asset token; and (iii) the attribute value pair, in a data record in memory.

10. The computer implemented method of claim 1, wherein:
the request to create an event token and the request to populate the event token are received at a first address of a first smart contract, the first smart contract configured to perform said creating the event token using the unique asset token identifier, and said modifying the event token to comprise the at least one attribute value pair; and
the asset token modification request is received at a second address of a second smart contract, the second smart contract configured to perform said modifying the asset token.

11. The computer implemented method of claim 1, further comprising committing a block to the blockchain, said block comprising at least one transaction comprising the at least one attribute identifier of the asset token and its associated unique event token identifier of the event token.

12. The computer implemented method of claim 1, further comprising transmitting the request to create an event token and the request to populate the event token to one or more further blockchain nodes of the blockchain network.

13. The computer implemented method of claim 1, further comprising transmitting the asset token modification request to one or more further blockchain nodes of the blockchain network, each of the one or more further blockchain nodes maintaining a copy of the asset token in memory.

14. A non-transitory computer readable storage medium comprising computer readable instructions that, when read by a computing device, cause the computing device to:
receive a request to create an event token, the request comprising a unique asset token identifier associated with an asset token, wherein the asset token comprises at least one attribute identifier identifying an attribute of the asset;
create an event token using the unique asset token identifier, the event token comprising a unique event token identifier;
receive a request to populate the event token, identified with the unique event token identifier, with at least one attribute value pair, each of the at least one attribute value pair comprising (i) an attribute identifier of the least one attribute identifier, and (ii) an attribute value for said attribute identifier;
modify the event token to comprise the at least one attribute value pair;
receive an asset token modification request, the asset token modification request comprising the unique asset token identifier and the unique event token identifier, and identifying the attribute identifier of the at least one attribute value pair;
modify the asset token associated with the unique asset token identifier so that each attribute identifier in the asset token of the at least one attribute value pair are associated with the unique event token identifier of the event token, the event token comprising the attribute value for each attribute identifier of the at least one attribute value pair; and
after said modification, broadcast the asset token over the blockchain network for inclusion on the blockchain.

15. A computing device comprising a processor and memory, the memory storing instructions which, when executed by the processor cause the computing device to:
receive a request to create an event token, the request comprising a unique asset token identifier associated with an asset token, wherein the asset token comprises at least one attribute identifier identifying an attribute of the asset;
create an event token using the unique asset token identifier, the event token comprising a unique event token identifier;
receive a request to populate the event token, identified with the unique event token identifier, with at least one attribute value pair, each of the at least one attribute value pair comprising (i) an attribute identifier of the least one attribute identifier, and (ii) an attribute value for said attribute identifier;
modify the event token to comprise the at least one attribute value pair;
receive an asset token modification request, the asset token modification request comprising the unique asset token identifier and the unique event token identifier, and identifying the attribute identifier of the at least one attribute value pair;
modify the asset token associated with the unique asset token identifier so that each attribute identifier in the asset token of the at least one attribute value pair are associated with the unique event token identifier of the event token, the event token comprising the attribute value for each attribute identifier of the at least one attribute value pair; and
after said modification, broadcast the asset token over the blockchain network for inclusion on the blockchain.

16. A computer implemented method of retrieving data associated with an asset that is stored on a blockchain, the method performed on a blockchain node of a blockchain network and comprising:
receiving, from a computing device, a first information retrieval request requesting contents of an asset token, the information retrieval request comprising a unique asset token identifier associated with the asset token, wherein the asset token comprises at least one attribute identifier identifying an attribute of the asset;
transmitting the contents of the asset token to the computing device;
receiving, from the computing device, a second information retrieval request comprising the unique asset token identifier and an attribute identifier of the at least one attribute identifier;
identifying at least one attribute value associated with the attribute identifier, each of the at least one attribute value stored in a respective event token which is stored on the blockchain and comprises a unique event token identifier; and
transmitting the at least one attribute value to the computing device.

17. The computer implemented method of claim 16, wherein a plurality of attribute values are identified for the attribute identifier, the method comprising outputting the plurality of attribute values in an ordered sequence in dependence on a time of creation of the event tokens comprising the plurality of attribute values.

18. The computer implemented method of claim 16, wherein the method is performed by a first smart contract on the blockchain node, and the first information retrieval request is addressed to the first smart contract.

19. The computer implemented method of claim 18, wherein the identifying at least one attribute value associated with the attribute identifier comprises:
identifying, from the asset token, a unique event token identifier associated with the attribute identifier; and
accessing an event token using the unique event token identifier to identify an attribute value associated with the attribute identifier as part of an attribute value pair.

20. The computer implemented method of claim 19, wherein the attribute value pair in the event token is associated with a previous event token identifier field, the method comprising:
determining, from the previous event token identifier field, a unique event token identifier of a preceding event token that was created before the event token;
accessing the preceding event token; and
identifying, from the preceding event token, an attribute value for said attribute identifier that the event token updated.

21. The computer implemented method of claim 19, wherein the attribute value pair in the event token is associated with a previous event token identifier field, the method comprising determining from the previous event token identifier field that the attribute value is an initial value for said attribute identifier.

22. The computer implemented method of claim 21, wherein the method is performed by the blockchain node, outputting the contents of the asset token comprises transmitting the contents of the asset token to the computing device; and outputting the at least one attribute value comprises transmitting the at least one attribute value to the computing device.

23. The computer implemented method of claim 22, wherein the first information retrieval request comprises an address of a first smart contract, the method comprising accessing the asset token by querying a first portion of memory using the unique asset token identifier, the first portion of memory associated with the address of the first smart contract.

24. The computer implemented method of claim 22 or 23, wherein the identifying at least one attribute value associated with the attribute identifier comprises:
determining from the asset token an address of a second smart contract which last generated an event token comprising an attribute value associated with the attribute identifier;
querying a second portion of memory using the unique asset token identifier and the attribute identifier, the second portion of memory associated with the address of the second smart contract; and
in response to said querying, retrieving one or more data records generated by the second smart contract, each of the data records comprising: (i) the unique asset token identifier; (ii) the attribute identifier; and (iii) an attribute value of the at least one attribute value, said attribute value associated with the attribute identifier.

25. The computer implemented method of claim 24, wherein each of the data records are recorded on the blockchain, and each data record comprises a unique transaction identifier identifying a transaction on the blockchain comprising the data record, wherein the method further comprises transmitting the unique transaction identifier of each of the data records to the computing device.

26. A non-transitory computer readable storage medium comprising computer readable instructions that, when read by a computing device, cause the computing device to:
receive, from a remote computing device, a first information retrieval request requesting contents of an asset token, the information retrieval request comprising a unique asset token identifier associated with the asset token, wherein the asset token comprises at least one attribute identifier identifying an attribute of the asset;
transmit the contents of the asset token to the remote computing device;
receive, from the remote computing device, a second information retrieval request comprising the unique asset token identifier and an attribute identifier of the at least one attribute identifier;
identify at least one attribute value associated with the attribute identifier, each of the at least one attribute value stored in a respective event token which is stored on the blockchain and comprises a unique event token identifier; and
transmit the at least one attribute value to the remote computing device.

27. A computing device comprising a processor and memory, the memory storing instructions which, when executed by the processor cause the computing device to:
receive, from a remote computing device, a first information retrieval request requesting contents of an asset token, the information retrieval request comprising a unique asset token identifier associated with the asset token, wherein the asset token comprises at least one attribute identifier identifying an attribute of the asset;
transmit the contents of the asset token to the remote computing device;
receive, from the remote computing device, a second information retrieval request comprising the unique asset token identifier and an attribute identifier of the at least one attribute identifier;
identify at least one attribute value associated with the attribute identifier, each of the at least one attribute value stored in a respective event token which is stored on the blockchain and comprises a unique event token identifier; and
transmit the at least one attribute value to the remote computing device.
